(19) United States
(12) Patent Application Publication
(10) Pub. No.: US 2016/0098440 A1
(43) Pub. Date: Apr. 7, 2016

(54) VALIDATION OF SEGMENTED DATA ENTRIES

(71) Applicant: Microsoft Technology Licensing, LLC, Redmond, WA (US)

(72) Inventors: Kimberly A. Nelson, Fargo, ND (US); Raymond J. Ridl, Fargo, ND (US); Jeffrey R. Anderson, Fargo, ND (US); Sanket M. Vasa, Fargo, ND (US); David E. Johnson, Fargo, ND (US); William L. Frandsen, Fargo, ND (US); Jason B. Stone, West Fargo, ND (US)

(21) Appl. No.: 14/506,910

(22) Filed: Oct. 6, 2014

(51) Int. Cl. G06F 17/30; G06F 3/0484

(52) U.S. Cl. CPC G06F 17/30371; G06F 17/30575; G06F 3/04842

(57) ABSTRACT

A data entry control is displayed at a client system, with user input mechanisms that allow a user to enter either unstructured data, or structured data. When the user enters information, a pre-segmentation validation is performed on the client system and the displayed data entry control is updated based on pre-segmentation results. When a server call is made to perform a server-side segmentation, the segmentation results received from the server are merged into the segmentation results on the client system.

### BACKGROUND

Computer systems are in wide use. Some computer systems allow users to perform data entry operations to enter segmented data.

By way of example, some such computer systems include business systems. Business systems can include, for instance, customer relations management (CRM) systems, enterprise resource planning (ERP) systems, line-of-business (LOB) systems, among others. Other systems that allow users to perform data entry include electronic mail systems that allow users to enter email addresses, for instance. These types of computer systems often store and manipulate data that is segmented data. For instance, in some such systems, customer account information is represented by segmented data. A first segment of the data may represent a main account number. A second segment may represent a department. A third segment may represent a business unit. Additional segments may represent a cost center, a specific project, etc. All of this information can be captured in a segmented manner. The positions of the values in the segments can indicate a context or domain for the value. The segment values and positions can be consumed for a variety of reasons, such as aggregation by segments or segment combinations, reporting, etc.

Another example of segmented data in a business system may include product numbers. For instance, a first segment in a product number may represent an overall product. A second segment may represent a particular style of that product, and additional products may represent product color, product size, etc.

Still other examples of segmented data may include bank account numbers with multiple segments, inventory tracking numbers with multiple segments, shipping label numbers with multiple segments, etc. These are given as examples only and a wide variety of other types of segmented data are sometimes used.

In some current systems, a user can enter segmented data in a number of different ways. In accordance with one current example, a data entry control provides a single text box so a user simply enters the segmented data as a string of characters, separated by recognized separators, in an unstructured way. In another example, a data entry control provides a plurality of different text boxes, each associated with a given segment. When a user finishes entering data into one of the text boxes, the system blocks the user from entering data into any of the other text boxes while performing a segment validation on the currently entered segment. In other scenarios, the number of segments can be variable, so the value entered in one segment can impact the number of additional segments that exist. For instance, assume a user is entering a main account number associated with “travel expense”. A new segment may appear requiring the user to enter “airline”, whereas other main accounts would not have this segment. This structural change impacts where the cursor goes when the user tabs out of the current segment. Thus, the user may be blocked until the segmentation is validated. It should also be noted that, some such computer systems are deployed in a relatively high latency environment, which can increase the time that a user is blocked.

The discussion above is merely provided for general background information and is not intended to be used as an aid in determining the scope of the claimed subject matter.

### SUMMARY

A data entry control is displayed at a client system, with user input mechanisms that allow a user to enter either unstructured data, or structured data. When the user enters information, a pre-segmentation validation is performed on the client system and the displayed data entry control is updated based on pre-segmentation results. When a server call is made to perform a server-side segmentation against master data on the server, the segmentation results received from the server are merged into the segmentation results on the client system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a segmentation validation architecture.

FIGS. 2A and 2B (collectively referred to herein as FIG. 2) illustrate a flow diagram showing one example of the operation of the segmentation validation architecture shown in FIG. 1.

FIGS. 3A and 3B show examples of user interface displays illustrating data entry controls.

FIG. 4 is a flow diagram illustrating one example of the operation of a segmentation merging component (shown in FIG. 1) in merging server segmentation results.

FIG. 5 is a block diagram of the architecture shown in FIG. 1, deployed in a cloud computing architecture, as but one example.

FIGS. 6-8 show various examples of mobile devices.

FIG. 9 is a block diagram of one example of a computing environment which can be used in the architectures shown in FIGS. 1 and 5.

### DETAILED DESCRIPTION

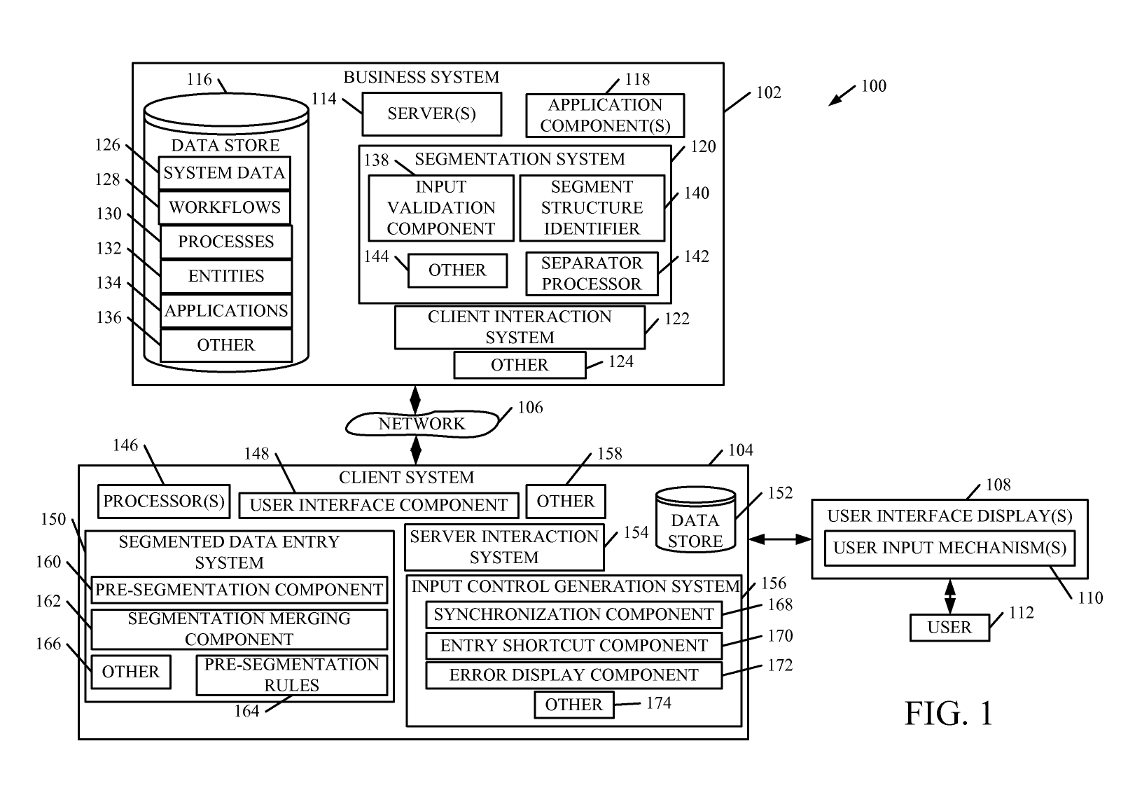

FIG. 1 is a block diagram of one example of a segmentation validation architecture 100. Architecture 100 illustratively includes business system 102 and client system 104. Client system 104 illustratively accesses business system 102 over network 106, which can be a wide area network, a local area network, etc. Client system 104 illustratively generates user interface displays 108 with user input mechanisms 110 for interaction by user 112. User 112 illustratively interacts with user input mechanisms 110 in order to control and manipulate client system 104, and business system 102.

User interface displays 108 can include user input mechanisms 110 which comprise data entry user input mechanisms. These mechanisms illustratively allow user 112 to perform data entry operations to enter segmented data. In the example described herein, the segmented data will be discussed in terms of account information where an account number comprises multiple segments. Of course, this is only described for the sake of example, and a wide variety of other segmented data can be processed as well.

The example shown in FIG. 1 illustrates that business system 102 can include one or more servers 114, data store 116, application components 118, segmentation system 120, client interaction system 122, and it can include other items 124 as well. Data store 116 illustratively includes system setup data 126, which can include account number data for all accounts in system 102, and a variety of other setup data. Data store 116 also illustratively includes workflows 128, processes 130, entities 132, applications 134, and it can include a wide variety of other business data 136. Application components 118 illustratively run applications 134 to operate on entities 132 and other data 136 and to perform processes, workflows, etc. These illustratively generate user interface displays that user 112 can interact with in performing his or her tasks for the organization that uses business system 102.

FIG. 1 also shows that, in one example, client system 104 illustratively includes one or more processors 146, user interface component 148, segmented data entry system 150, data store 152, server interaction system 154, input control generation system 156, and it can include other items 158. User interface component 148 illustratively, either by itself or under the control of other items, generates user interface displays 108.

Before describing the overall operation of system 100 in more detail, a brief overview of some of the items in architecture 100 will first be provided, along with a brief overview of the operation of architecture 100 in performing data segmentation validation.

Entities 132 illustratively represent things in business system 102. For instance, an account entity describes and represents an account. A vendor entity describes and represents a vendor. A customer entity describes and represents a customer. A product entity describes and represents a product. A business opportunity entity describes and represents a business opportunity, etc. Application components 118 can illustratively run a variety of different applications 134 to operate on the entities 132 in performing processes, workflows, etc. The applications 134 can include, for instance, a general ledger application (or other accounting applications), inventory tracking applications, opportunity tracking or project management applications, purchasing or billing applications, among others.

Segmentation system 120 illustratively includes input validation component 138, segment structure identifier 140, separator processor 142, and it can include other items 144. As is described in greater detail below, segmentation system 120 illustratively receives data entered by user 112 and performs segmentation validation on the data against the system setup data 126 stored in data store 116. It returns the validation information indicating a segmentation structure and whether the segmentation is valid. That information is merged into the segmented data being processed at client system 104.

Client interaction system 122 illustratively performs the operations that are used in interacting with one or more client systems 104. While only a single client system 104 is shown, this is by way of example only and multiple client systems can be used as well.

In client 104, segmented data entry system 150 illustratively includes pre-segmentation component 160, segmentation merging component 162, pre-segmentation rules 164, and it can include other items 166. When segmented data is entered by user 112, pre-segmentation component 160 illustratively accesses pre-segmentation rules 164 (and possibly information in data store 152 or other items), and performs a pre-segmentation validation on the data entered by user 112. It provides the results of the pre-segmentation operation to input control generation system 156. When segmentation validation results are received from the server environment of business system 102, segmentation merging component 162 illustratively merges those results into the pre-segmentation results generated by component 160. This information is also provided to input control generation system 156.

System 156, itself, illustratively includes synchronization component 168, entry shortcut component 170, error display component 172, and it can include other items 174. Input control generation system 156 illustratively generates the data entry control that user 112 uses to enter the segmented data. Synchronization component 168 illustratively keeps the various user input mechanisms on that control in sync with one another. For instance, where there is an unstructured data user input mechanism and the user is entering unstructured data into that user input mechanism, there may also be a structured data user input mechanism in which different segments are broken out. As the user is entering data in the unstructured data user input mechanism, synchronization component 168 illustratively synchronizes the segmentation being displayed in the structured data user input mechanism as well. Entry shortcut component 170 illustratively processes data entry shortcuts (such as where the user uses the tab key, the enter key, or other shortcut keystrokes, etc.). Error display component 172 illustratively generates displays of display elements that indicate that a user has made an error in entering segmented data. All of these items are described in greater detail below.

As a brief overview of the operation of architecture 100 in performing segmentation validation, user 112 illustratively begins performing data entry operations on a user input control that receives segmented data. Pre-segmentation component 160 performs an initial segmentation validation on the entered data and updates the user input control based upon the pre-segmentation results. Server interaction system 154 illustratively makes asynchronous calls to the server environment of business system 102 to have segmentation system 120 perform a segmentation validation on the data that has been entered, thus far, by user 112. When the server call is returned with the segmentation results, segmentation merging component 162 merges those results into the results currently being displayed to the user 112 on the user input control. This continues until a final data segmentation is achieved.

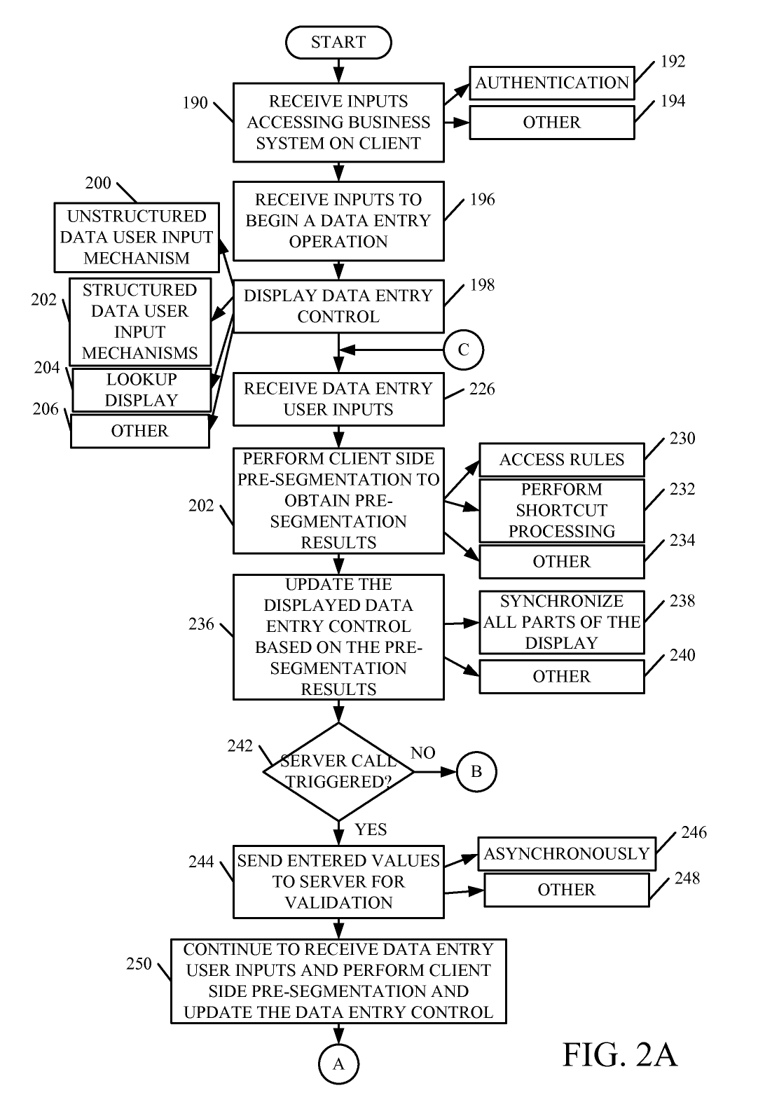

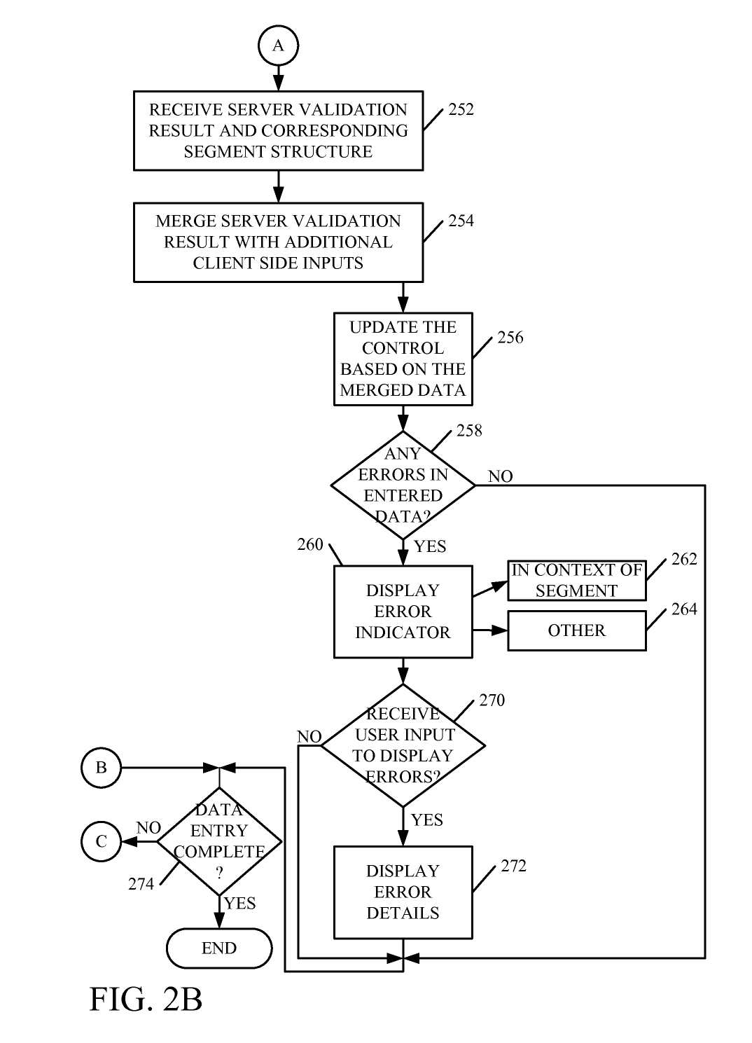

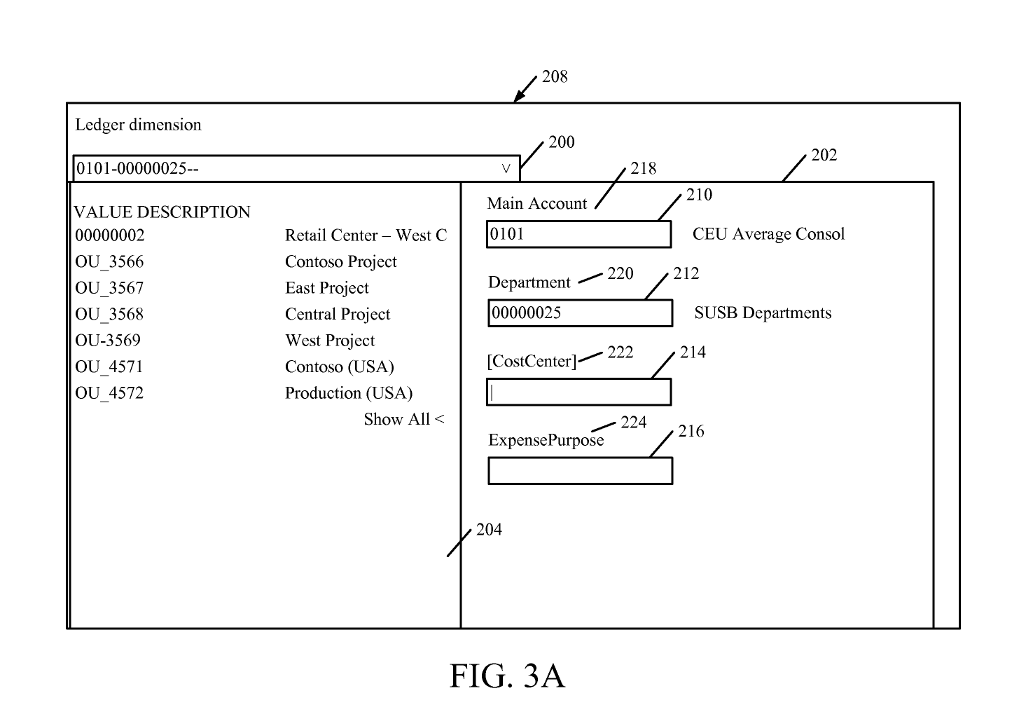

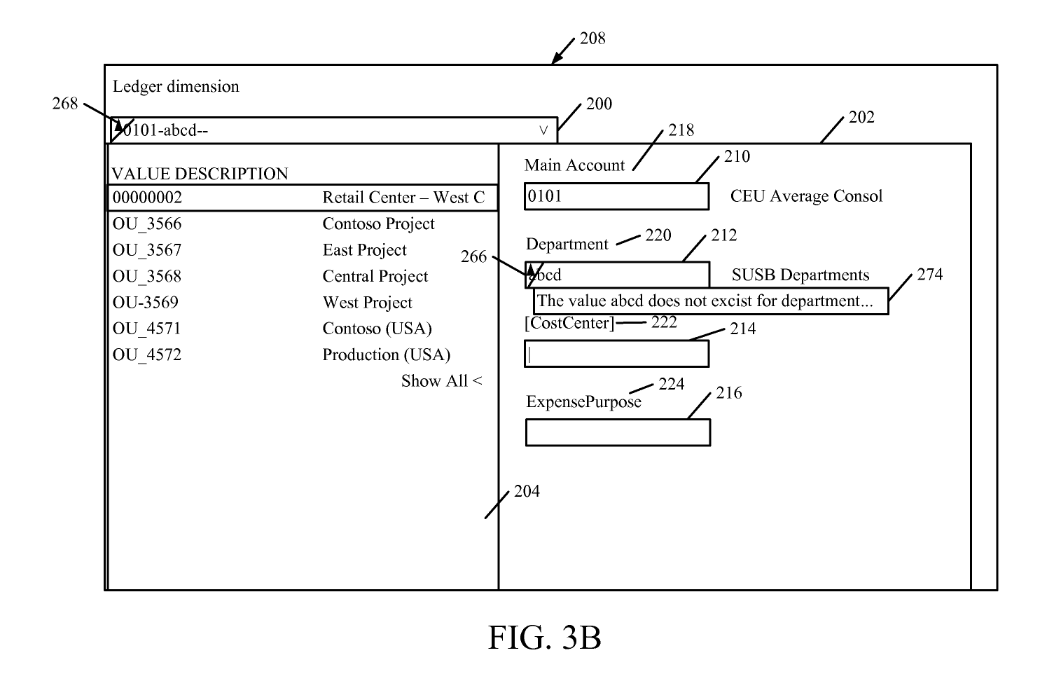

FIGS. 2A and 2B (collectively referred to herein as FIG. 2) show a flow diagram illustrating one example of the operation of architecture 100 in performing validation of segmentation data as it is being entered by user 112. FIGS. 3A and 3B show examples of user interface displays that illustrate a user input control for receiving segmented data. FIGS. 1-3B will now be described in conjunction with one another.

User 112 first provides inputs to client system 104 indicating that the user wishes to access business system 102 through client system 104. This is indicated by block 190 in FIG. 2. For instance, user 112 can provide authentication information 192 to log into the system. The user can provide other inputs 194 as well. User 112 then provides inputs indicating that the user wishes to begin a data entry operation. This is indicated by block 196. For instance, the user can call up a form in business system 102 that asks the user to enter account information. The inputs indicating that the user wishes to begin data entry can be a wide variety of other inputs as well.

In response, input control generation system 156 illustratively displays a data entry control for the user to begin entering data. This is indicated by block 198. In one example, the data entry control can have a user input mechanism for entering the data in an unstructured way. This is indicated by block 200. In another example, the control can have a user input mechanism that allows the user to enter structured data. This is indicated by block 202. The control can also have a lookup display 204 that displays information based upon what the user has already entered. For instance, as discussed in more detail below, the lookup display 204 can show a set of values for each segment that can be selected for entry. If the user has not yet entered any data, the lookup display 204 can show a list of all values for a first available segment. As the user enters data, the list can be trimmed to show values that are valid, given what the user has already entered. The control can have other parts as well, and this is indicated by block 206.

FIG. 3A shows one example of a data entry control user interface display 208. In the example shown in FIG. 3A, user interface display 208 illustratively has an unstructured data user input mechanism 200. In the example illustrated, mechanism 200 comprises a text box for receiving a string of characters. FIG. 3A also shows that the control can include structured data user input mechanism 202. In the example illustrated, mechanism 202 is a fly out display that includes a plurality of text boxes 210, 212, 214 and 216. Each of the text boxes 210-216 have a corresponding textual descriptive portion 218, 220, 222 and 224. Each text box 210-216 is provided to allow the user to enter a separate segment in the entered data. For instance, in the example in FIG. 3A, the user is entering an account number. Text box 210 allows the user to enter the first segment of the account number, corresponding to the main account number. Text box 212 allows the user to enter the next segment that corresponds to a department. Text box 214 allows the user to enter the third segment that corresponds to a cost center, and text box 216 allows the user to enter a segment corresponding to an expense purpose.

Display 208 also illustratively includes the lookup display portion 204. Display portion 204 shows account numbers that match the information that has already been input by the user. This can be done in a number of ways. Input control generation system 156 can filter the displayed list of values based on what has been entered in unstructured data user input mechanism 200 and structured data user input mechanism 202. As one example, assume a full list of values includes:

| Name | Desc |
|---|---|
| 001 | Los Angeles |
| 002 | Detroit |
| 003 | Miami |
| 030 | Key West |
| 321 | West Omaha |

When the user opens the lookup display portion 204, the user will see all 5 rows. If the user types 0 into input mechanism 200, they will only see 001, 002, 003 030 (because system 156 matches on the natural key “name” column). If instead the user typed W, they would only see 030, 321 (because system 156 also matches on the description column). Upon user selection of 030 or 321 from the lookup 204 the “W” would be replaced with the appropriate row value entered.

As is further discussed below, in one example, the user can select items from display 204 and have their values entered in the user input mechanism using shortcuts.

When the user is entering segmented data into structured user input mechanism 200, the segmentation is already being performed by the user. However, the segmentation is initially validated on the client side during a pre-segmentation process, and it can also be intermittently validated in the server environment of business system 102.

When the user is entering information in unstructured data user input mechanism 200, the segmentation is initially performed using the pre-segmentation process in client system 104, and it is also intermittently validated by performing segmentation validation in the server environment of business system 102. In either case, synchronization component 168 in system 156 (shown in FIG. 1) illustratively synchronizes all of the display portions of control 208. For instance, as can be seen in FIG. 3A, the user has entered the sequence “0101-00000025--” into unstructured user input mechanism 200. Thus, synchronization component 168 identifies the dashes as segment separators and updates the structured data user input mechanism 202 to place the segments entered in mechanism 200 into the corresponding text boxes 210-216. Similarly, where the user enters information in text boxes 210-216, synchronization component 168 illustratively updates the unstructured data user input mechanism 200 so that it is synchronized with that information as well. Thus, component 168 inputs the segments of data in to mechanism 200, separated by the separators.

It will be noted that synchronization component 168 not only updates segment values but it also illustratively updates the segment structure displayed in structured data user input mechanism 202, based upon the information entered by the user. For instance, it may be that the subsequent segments in segmented data change based upon the particular content of the previous segments. By way of example, it may be that a certain department may have no cost centers. In that case, text box 214 will not be displayed when the user enters the segment number corresponding to that department in text box 212. Similarly, it may be that other departments not only have cost centers, but they ask the user to also enter a project number. In that case, an additional text box will be displayed corresponding to a project identifier segment. Updating the structured data entry user input mechanism 202 can be done in other ways as well. Receiving data entry user inputs is indicated by block 226 in the flow diagram of FIG. 2

While the user is typing information into the control, pre-segmentation component 160 is illustratively accessing pre-segmentation rules 164 (or other heuristics or data or functionality) and performing an estimate as to the proper segmentation of the information that is being input. The results of the pre-segmentation include a segmentation structure and segment values for the segments in the structure. Performing client side pre-segmentation to obtain pre-segmentation results is indicated by block 228, and doing this by accessing the rules is indicated by block 230.

As the user is entering data, and pre-segmentation component 160 is performing pre-segmentation, entry shortcut component 170 in input control generation system 156 processes any shortcut inputs that are provided by the user. These can be a wide variety of different keystrokes or character inputs. For instance, to aid in navigation within control 208, a number of keyboard shortcuts can be supported. By way of example, when lookup display 204 is open, the user can select the current highlighted value in the lookup for data entry by hitting the enter key. This places the highlighted lookup value in the segment currently being entered by the user and takes the user to a next segment for further data entry. To illustrate this further, and referring again to FIG. 3A, the user can select the top entry in lookup display 204 (so that it is highlighted) and hit the enter key. Because the cursor is placed in text box 214, entry shortcut component 170 will thus place the value “00000002” in text box 214 and move the cursor to text box 216. If the cursor were placed in text box 200, then entry shortcut component 170 would place that value after the final separator in text box 200, and add another separator at the end of it, and place the cursor after the final separator.

In another example, the tab key can be used to perform shortcuts in data entry. For instance, the behavior of the tab key can depend on whether the user is working in the unstructured data user input mechanism 200 or in the structured data user input mechanism 202. When the focus is in mechanism 200, and lookup display 204 is not open, then if the user hits the tab key, focus is illustratively moved out of text box 200. If the lookup display 204 is open, actuation of the tab key causes entry shortcut component 170 to place the currently highlighted value in the lookup display 204 as the value of the current segment under focus, and the focus is moved out of control 200. This behavior provides consistency with the normal behavior of allowing users to move between controls on a form using the tab key. When the focus is in the unstructured user input mechanism 202 (e.g., the fly out display), then if the user actuates the tab key, focus is moved to the next segment (e.g., the next text box 210-216) in mechanism 202. This behavior allows the user to traverse the currently known structure and perform data entry as desired.

It will be noted, of course, that the tab key and enter key are only examples. Also, the behavior discussed with respect to them is only an example. A wide variety of other keys, and different behaviors, can be provided for data entry shortcuts as well. Performing shortcut processing is indicated by block 232 in FIG. 2. The client side pre-segmentation can be performed in other ways as well. This is indicated by block 234.

The pre-segmentation results are used to update the displayed data entry control 208. By way of example, when the user has entered the text illustrated in FIG. 3A in unstructured data user input mechanism 200, the pre-segmentation component 160 interprets the information as having two segments. The first corresponds to the main account number 0101 and the second corresponds to the department number that begins with 0000002 (which the user is in the process of entering). Thus, pre-segmentation component 160 places those segments in text boxes 210 and 212, respectively. It also updates lookup display 204. It displays a set of likely next segments that are to be entered in text box 214 (or the next segments that is to be entered after the final separator in text box 200). Updating the displayed data entry control 208 based upon the pre-segmentation results is indicated by block 236 in FIG. 2. Synchronizing all of the different parts of the display is indicated by block 238. Of course, the display can be updated with the pre-segmentation results in other ways as well, and this is indicated by block 240.

It should also be noted that, even when the user is entering data in unstructured data user input mechanism 200, pre-segmentation component 160 illustratively determines the current segment that the user is interacting with (such as based upon the pre-segmentation rules 164 or otherwise), and synchronization component 168 illustratively displays the lookup display 204 with possible values for that particular segment. In this way, the user experience is similar to what a user would find when interacting with structured data (such as in structured data user input mechanism 202). However, the user advantageously need not face the problems associated with interacting with the structured data, such as the blocking behavior that sometimes accompanies that type of data entry.

At some point, the user will provide an input that triggers a server call to the segmentation system 120 in the server environment of business system 102. This is indicated by block 242 in FIG. 2. The server call can include a call to a server in any client/server architecture, a call to a disk system, a call to a remote server environment, a web service, etc. The inputs can be a wide variety of different inputs. For instance, where the user enters a character that is recognized as a separator in the control, this triggers server interaction system 154 to provide the currently entered information (through client interaction system 122 of business system 102) to input validation component 138 in segmentation system 120. In another example, where the user moves the focus out of the control (or out of a particular data user input mechanism in the control) this again causes server interaction system 154 to make a server call to validate the segmentation. These are examples only.

Where a server call has been triggered, server interaction system 154 sends the entered values to the server for validation. This is indicated by block 244. In one example, the server call is an asynchronous call, as indicated by block 246. Thus, input control generation system 156 can continue to receive user inputs on the data entry control, even before the server call returns. This avoids blocking the user and enabling the user to proceed with the rest of the data entry. Server interaction system 154 can send the entered values for validation in other ways as well, and this is indicated by block 248.

Input validation component 138 has access to the complete system setup data 126 in data store 116, including all account information. It can thus perform input validation and processing against this data, in the background relative to the data entry being performed at client system 104. For instance, it can perform lookups to see whether the data entered by the user matches valid account number segment data. Segment structure identifier 140 identifies the segment structure, once it is validated, and the call that indicates the validated segment structure and segment values returns to client system 104.

It may also happen that some segments contain characters that may otherwise be interpreted as separators. In one example, separator processor 142 processes this information to determine the individual segment values and the corresponding segmentation structure. For instance, if the hyphen character is identified as a separator, but a valid segment value contains a hyphen, separator processor 142 identifies this and outputs an indication that the hyphen is contained within the segment value, rather than being used as a segment separator. By way of example, assume that a main account number is “01-01”. Assume also, however, that the hyphen character can be used in system 102 as a segment separator. It may thus be difficult to determine whether the main account is actually “01” and the second segment is also “01”, (e.g., if the hyphen is a separator) or whether the main account segment value is actually “01-01” (e.g., if the hyphen is part of the segment value). When a next subsequent server call is made, separator processor 142 compares the values against the system setup data 126 to identify these instances and provide a correct segmentation structure and correct segment values.

While the segmentation system 120 in the server environment is performing validation on the values that it has received, input control generation system 156 continues to receive, through the data entry control, user inputs as the user is typing. It also continues to perform client side pre-segmentation and to update the data entry control based on the pre-segmentation results. This is indicated by block 250.

At some point, server interaction system 154 will receive the server validation results from segmentation system 120. Receiving the server validation results and the corresponding segment structure and segment value is indicated by block 252 in FIG. 2.

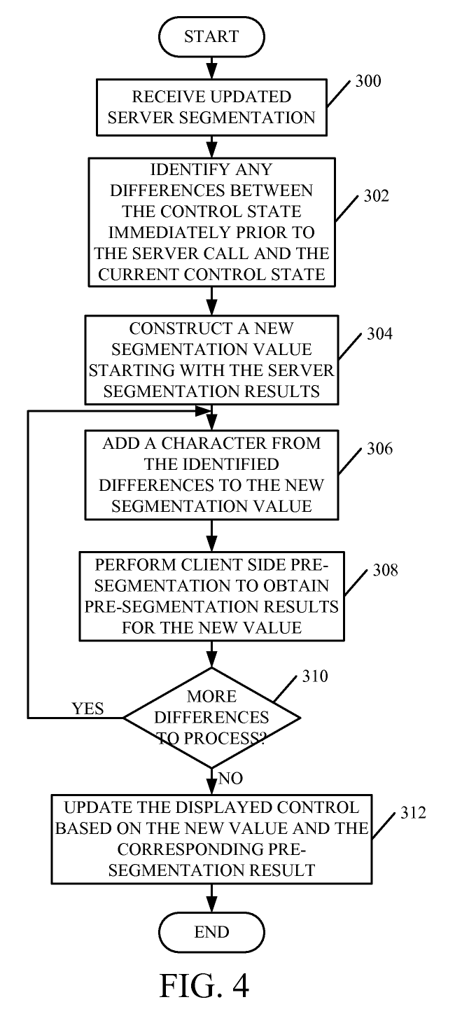

It may be that, while the server environment is processing the server call, user 112 has continued to enter data into the data entry control. In that case, segmentation merging component 162 illustratively merges the server validation result and corresponding segment structure and segment values returned by the server environment with the additional client side inputs. This is indicated by block 254 in FIG. 2. The merged results are provided to synchronization component 168 which updates the displayed control based upon the merged data. This is indicated by block 256 in FIG. 2. Merging the server validation result with the additional client side inputs is described in greater detail below with respect to FIG. 4.

Either the pre-segmentation component 160, or segmentation system 120, may identify that the user has made an error in segmentation, or an error in the data entry in a given segment. For instance, it may happen that the segmentation structure input by the user is valid, but one or more of the particular segment values was mis-typed. It may also happen that the segmentation structure input by the user is invalid. Determining whether any errors occur in the entered data is indicated by block 258 in FIG. 2. If so, then error display component 172 in system 156 displays an error display element indicating that an error exists. This is indicated by block 260. This can be done in the context of the segment in which the error occurs, or in other ways. This is indicated by blocks 262 and 264.

For instance, FIG. 3B shows one example of a user interface display that displays the entry control 208. Some of the items in FIG. 3B are similar to those shown in FIG. 3A, and they are similarly numbered. It can be seen in FIG. 3B, however, that the user has now entered the character string “abcd” in the second segment. The user may have done this by entering it into the unstructured data user input mechanism 200, or into the structured data user input mechanism 202 (e.g., in text box 212).

In the example shown in FIG. 3B, error display component 172 displays an error indicator 266 on the structured data user input mechanism 202, on the particular text box 212 where the error occurred. It also displays an error indicator 268 on the unstructured data user input mechanism 200 to indicate that an error exists somewhere in the entered data. Thus, a user can quickly and easily identify the particular segment where the error occurs, and can rectify that.

The user can also illustratively provide a user input to display more details about the identified errors. This is indicated by block 270 in FIG. 2. When this is received, error display component 172 displays additional information regarding the identified errors. This is indicated by block 272.

The user input to see the detailed information about an error display can take a wide variety of different forms. For instance, the user can select (such as click on or touch) one of the error indicators 266 or 268. In another example, the user can simply hover the cursor over one of the error indicators 266 and 268, and error display component 172 interprets this as a request to display additional information about the errors. For instance, as shown in FIG. 3B, the user is illustratively hovering over error indicator 266. This causes component 172 to display error message 274 indicating that the value in text box 212 does not exist for a department segment in an account number. In an example where multiple errors occur in different segments, an error indicator 266 will be displayed corresponding to each text box (representing each segment) where an error occurs. Where multiple errors occur within a single segment, then the detailed information 274 will describe all errors in the given segment. Where the user actuates or hovers over error indicator 268, component 172 illustratively displays or highlights the particular segment where the error occurs.

In addition, it may be that each individual segment value is valid, but the segment combination is invalid. For instance, it may be that there is no department “abed” for main account “0101”. In that case, error display component 172 will illustratively display an error indicator 266 on the first segment that is inconsistent in the entered data. The detailed information will indicate that, while the data in that segment may be valid, it is not valid when placed in combination with one or more of the previous segments, which will also be identified.

At this point, if the data entry operation is not yet complete, then processing reverts back to block 226 where additional data entry user inputs are received. This is indicated by block 274 in FIG. 2. The data entry operation will eventually end.

FIG. 4 is a flow diagram illustrating one example of the operation of segmentation merging component 162 in merging segmentation validation results (and the corresponding segment structure and segment values received from segmentation system 120 in the server environment) with additional user data inputs that have been received on client system 104 since the server call was made. In a multi-tier architecture, such as that shown in FIG. 1, there can be a latency between the time that data has been entered in client system 104, and the time when the validation process has been completed in the server environment and results have been returned to the client for display. Thus, for purposes of the description of FIG. 4, it is assumed that user 112 has provided additional inputs since the server call was made. Server interaction system 154 then receives the return from the server call. This includes the updated server segmentation results (e.g., the corresponding segmentation structure and segment values). This is indicated by block 300.

Segmentation merging component 162 then identifies any differences between the control state immediately prior to the server call and the current control state. This is indicated by block 302. As an example, component 162 illustratively recalls from memory the values that existed in the control 208 when the server call was made. It then performs a comparison to identify any differences between that value and the current value in the control. It should be noted that, in one example the differences are only the differences that exist, and not the differences that may have existed at one point. For instance, if the user entered four characters since the server call was made, but then deleted three of them, merging component 162 would identify the difference as only the single remaining character that was entered (and not deleted) since the server call was made.

Once the differences are identified, merging component 162 constructs a new segmentation value starting with the server segmentation results. This is indicated by block 304. For instance, it is assumed that the server segmentation structure and segment values that have been returned by the server are correct. Merging component 162 thus generates the new segmentation value, beginning with the server segmentation results, because it knows that the server segmentation results are correct.

Merging component 162 then adds a character from the identified differences to the new segmentation value. This is indicated by block 306. It then performs the client side pre-segmentation operation to obtain pre-segmentation results for the new value. Having pre-segmentation component 160 perform pre-segmentation on the new value is indicated by block 308.

Merging component 162 then determines whether there are any more differences. This is indicated by block 310. If so, processing reverts to block 306 where the next character in the identified differences is added to the new result and block 308 where pre-segmentation component 160 performs pre-segmentation on that new segmentation value. This continues, with merging component 162 adding the differences, character-by-character, to the segmentation result returned from the server, until all the newly added characters have been added, and the pre-segmentation operation has been performed to estimate the segmentation structure of the new value (with all of the newly entered characters added to the server result). Once all of the newly entered characters have been added and pre-segmentation has been performed on all of them (as determined at block 310) processing continues at block 312 where synchronization component 168 updates the displayed control 208 based on the new value and the corresponding pre-segmentation result. At this point in the process, if the differences identified at block 302 trigger another service call, (such as if the differences contain a separator character), then a new server request is sent, similar to the one sent at block 242. The results of that server call then return at block 300, and merging is repeated.

The present description thus advantageously provides an approach that makes it easy for users to enter segmented data in a high latency environment, without experience blocking. It allows the user to enter data quickly if the user knows the structure of the segments, without waiting for the system to process or validate the data and update the state of the data entry control. It also provides visual aids to guide the user in entering data in a required structure. In addition, if the user types quickly, the system can process the entered data and update the visual aids to reflect the new structure.

Further, because pre-segmentation is performed on client system 104, the client system 104 makes an initial guess as to what the individual segment values are. This allows the user to continue modifying the account number combination immediately, while still seeing some sort of structural information, without having to wait for the server call to return. Once the call from the server returns, and the correct segmentation information is known, the client side merging component in client system 104 then updates the data entry control to reflect this.

The server call can be made asynchronously, thus avoiding blocking the client and enabling the user to proceed with the rest of the data entry. The user can also enter data in an unstructured way, (such as if they know the structure from experience) or they can choose to enter data in a structured manner. Regardless of where the user is performing data entry, the control always maintains the data in the various portions of the displayed control, in sync with one another. This allows the user to select from among the different approaches, and even switch between them.

The present description also indicates that the control is able to determine the current segment that the user is interacting with and display lookup values for that segment. Because the lookup values are displayed even based on the pre-segmentation results, the user has an experience of interacting with the server, without experiencing any blocking issues.

The present description also provides mechanisms to automatically process shortcuts and to merge data received from the server with more recently entered data on the client, and update the displayed control based upon the merged results. Further, the present description provides a contextual error indication that allows the user to quickly and easily identify and correct errors in data entry or in segmentation sequences or combinations.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

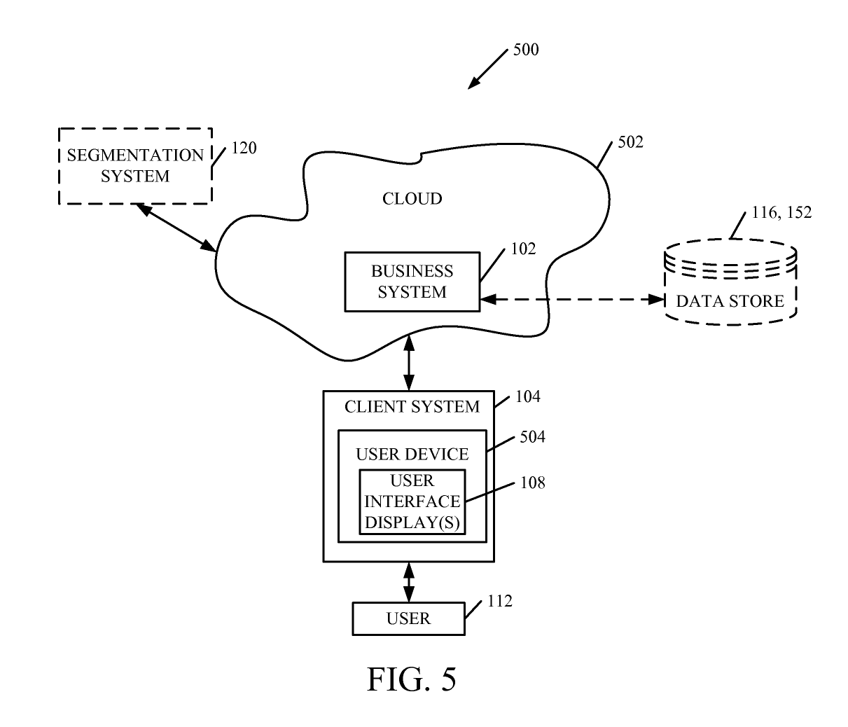

While architecture 100 can be deployed in a variety of different configurations (such as a rich client/server architecture without using a wide area network, or other architectures), FIG. 5 is a block diagram of an example of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that business system 102 can be located in cloud 502 (which can be public, private, or a combination where portions are public while others are private). Therefore, user 112 uses a user device 504 that includes some or all of client system 104 to access those systems through cloud 502.

FIG. 5 also depicts another example of a cloud architecture. FIG. 5 shows that it is also contemplated that some elements of architecture 100 can be disposed in cloud 502 while others are not. By way of example, data stores 116 and/or 152 can be disposed outside of cloud 502, and accessed through cloud 502. In another example, segmentation system 120 (or other items) can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

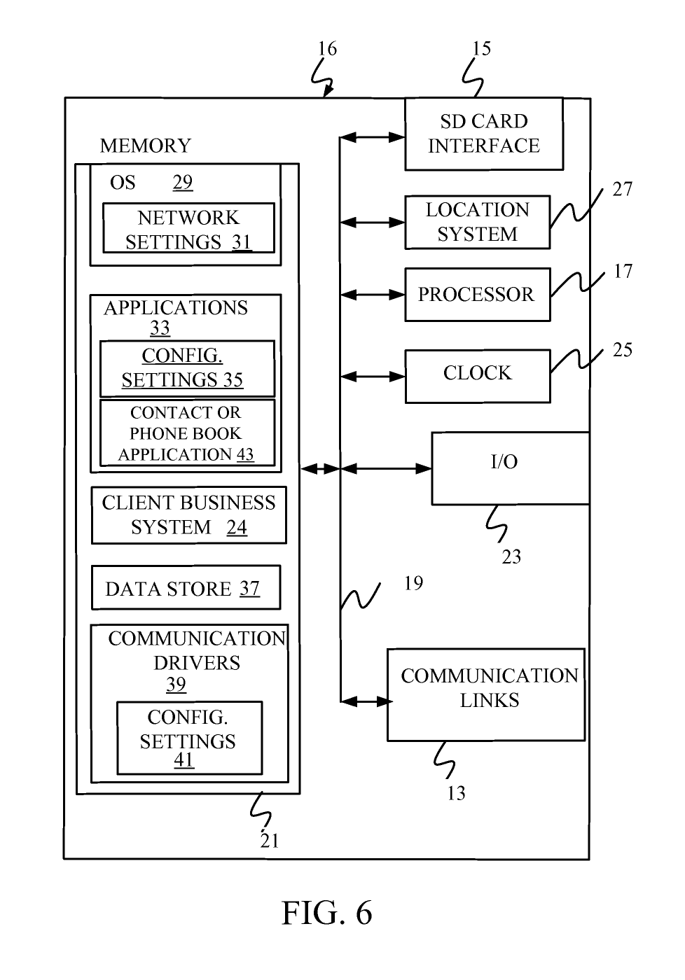

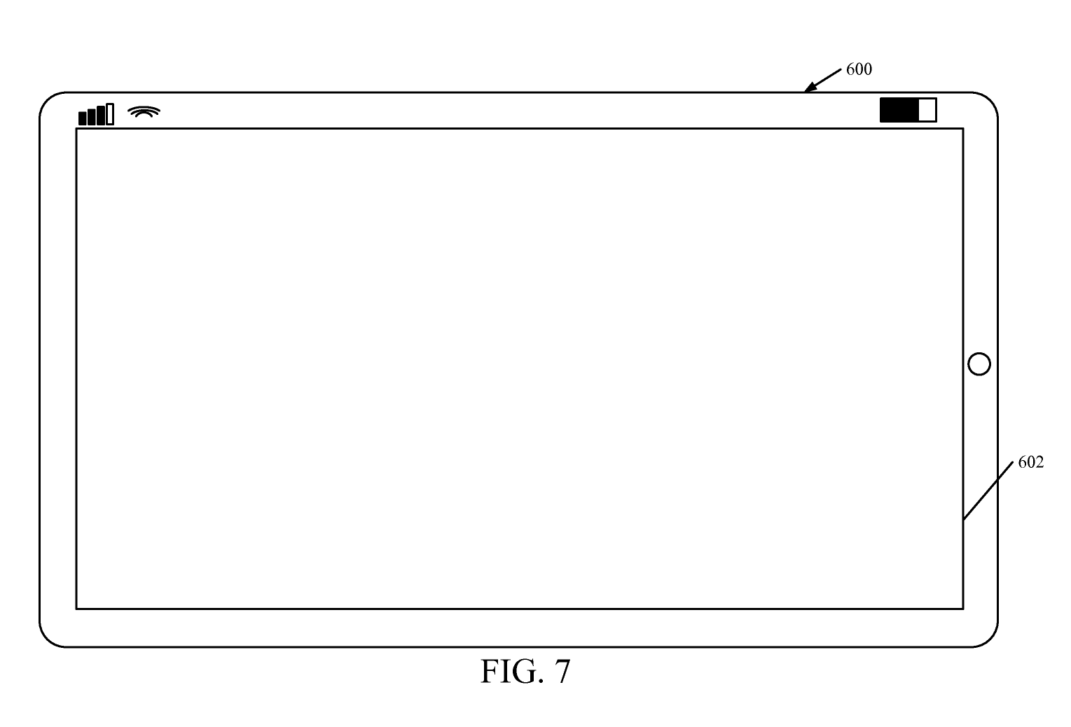

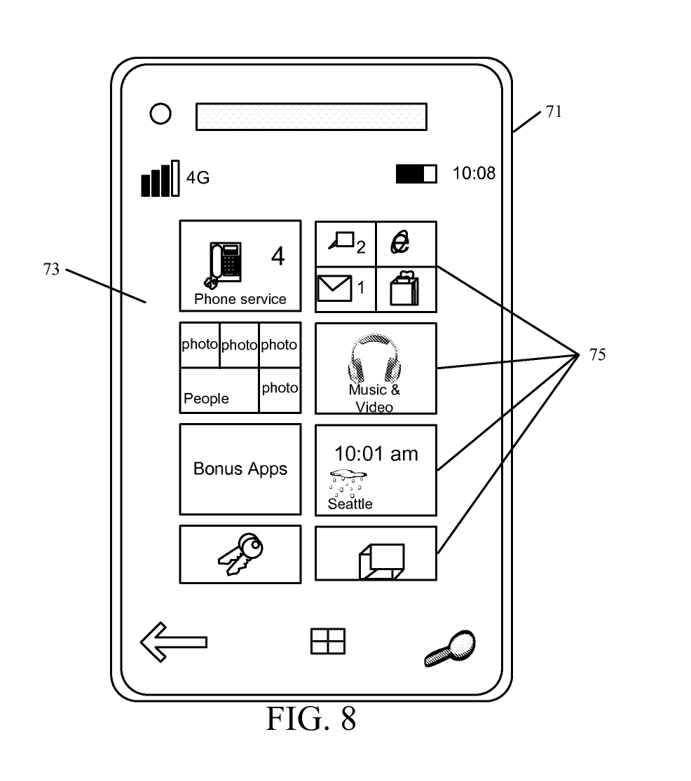

FIG. 6 is a simplified block diagram of one illustrative embodiment of a handheld or mobile computing device that can be used as a user's or client's hand held device 16, in which the present client system (or parts of it) can be deployed. FIGS. 7-8 are examples of handheld or mobile devices.

FIG. 6 provides a general block diagram of the components of a client device 16 that can run components of client system 104 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 146 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of client system 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 6, computer 600 is shown with user interface display from FIG. 3A displayed on the screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples, the phone also includes a Secure Digital (SD) card slot that accepts a SD card.

The mobile device can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

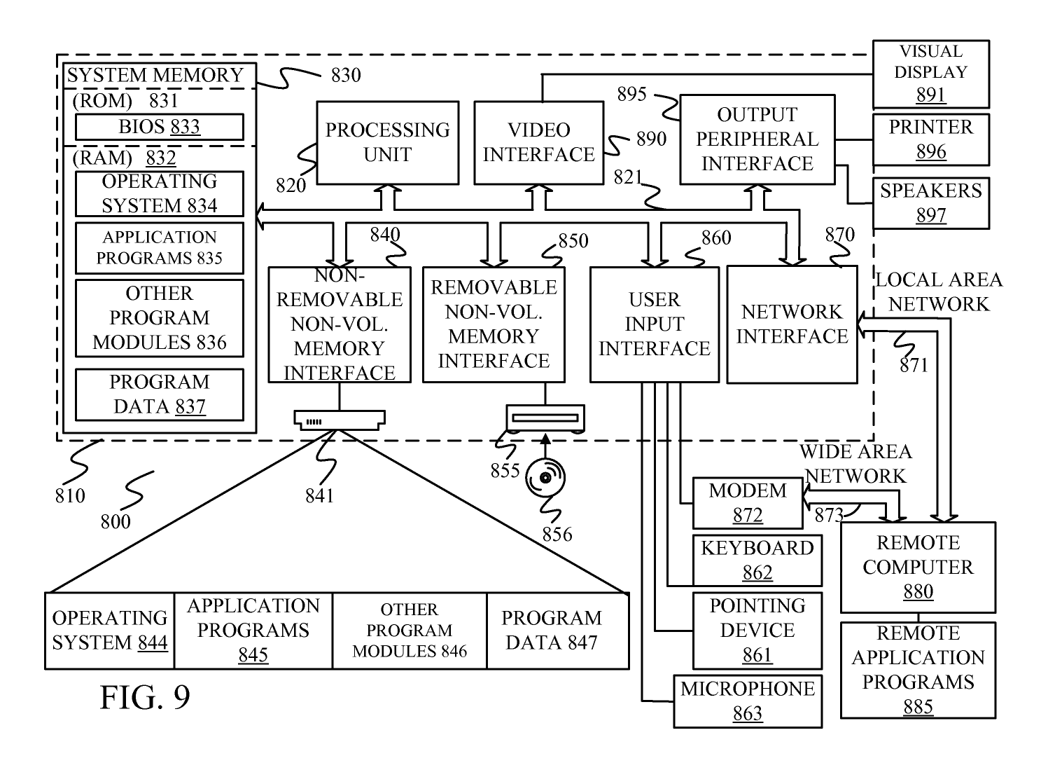

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise servers 114 or processor 146), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an input control generation system that generates an input control display that has a data entry user input mechanism configured to receive segmented data;

a pre-segmentation component configured to perform a pre-segmentation validation of the segmented data to obtain a pre-segmentation result; and

a segmentation merging component configured to receive a server segmentation validation result and merge it with the pre-segmentation result to obtain a merged segmentation result, the input control generation system updating the input control display based on the merged segmentation result.

Example 2 is the computing system of any or all previous examples wherein the input control generation system is configured to generate the input control display with a structured data user input mechanism configured to receive the segmented data in a displayed segment structure, and an unstructured data user input mechanism configured to receive the segmented data in an unstructured form.

Example 3 is the computing system of any or all previous examples and further comprising:

a synchronization component configured to receive the segmented data in at least one of the structured data user input mechanism and the unstructured data user input mechanism and synchronize data displayed in at least another of the structured data user input mechanism and the unstructured data user input mechanism.

Example 4 is the computing system of any or all previous examples and further comprising:

a server interaction system configured to detect a server call trigger and, in response, make an asynchronous server call with the received, segmented data, to obtain the server segmentation validation result.

Example 5 is the computing system of any or all previous examples and further comprising:

an error display component configured to display an error indicator on the input control display indicative of an error in the received, segmented data.

Example 6 is the computing system of any or all previous examples wherein the error display component generates the error indicator in a segment context that indicates an erroneous segment.

Example 7 is the computing system of any or all previous examples wherein the structured data user input mechanism includes a plurality of separate user input mechanisms, one corresponding to each of a plurality of different segments.

Example 8 is the computing system of any or all previous examples wherein the error display component displays an error indicator proximate each separate user input mechanism that corresponds to an erroneous segment.

Example 9 is the computing system of any or all previous examples wherein the error display component is configured to receive user selection of a displayed error indicator and, in response, display error detail information corresponding to the indicated error in the received, segmented data.

Example 19 is the computing system of any or all previous examples wherein the error detail information identifies a segment that has an erroneous segment value.

Example 11 is the computing system of any or all previous examples wherein the error detail information identifies a segment that is in an erroneous segment combination or in an erroneous segment sequence.

Example 12 is the computing system of any or all previous examples wherein the segmentation merging component identifies differences between data received through the data entry user input mechanism when the asynchronous server call is made and data received through the data entry user input mechanism when the server segmentation validation result is received and obtain a pre-segmentation result based on the server segmentation validation result and the differences.

Example 13 is the computing system of any or all previous examples wherein the segmentation merging component is configured to add the differences, character-by-character, to the server segmentation validation result, and, after adding each character, obtain a pre-segmentation result until all differences have been added to the server segmentation validation result, to obtain the merged segmentation result.

Example 14 is a method, comprising:

displaying, on a client system, an input control display that has a data entry user input mechanism;

receiving segmented data through the data entry user input mechanism;

perform a pre-segmentation validation of the received, segmented data, on the client system to obtain a pre-segmentation result;

making an asynchronous server segmentation call to a server segmentation system;

receiving a server segmentation result from the server segmentation system, at the client system;

merging the server segmentation result with the pre-segmentation result to obtain a merged segmentation result; and

updating the input control display based on the merged segmentation result.

Example 15 is the method of claim 14 wherein displaying an input control display comprises:

displaying a structured data user input mechanism configured to receive the segmented data in a displayed segment structure; and

displaying an unstructured data user input mechanism configured to receive the segmented data in an unstructured form.

Example 16 is the method of any or all previous examples and further comprising:

synchronizing data displayed in the structured data user input mechanism and the unstructured data user input mechanism, based on data entered in the structured data user input mechanism or the unstructured data user input mechanism.

Example 17 is the method of any or all previous examples wherein merging comprises:

detecting differences between data received through the data entry user input mechanism when the asynchronous server call is made and data received through the data entry user input mechanism when the server segmentation result is received; and

performing pre-segmentation validation, on the client system, to obtain a pre-segmentation result based on the server segmentation result and the differences.

Example 18 is the method of any or all previous examples and further comprising:

displaying an error indicator, identifying a segment context, on the input control display indicative of an error in the received, segmented data.

Example 19 is a client computing system, comprising:

an input control generation system that generates an input control display that has a data entry user input mechanism configured to receive segmented data;

a pre-segmentation component configured to perform a pre-segmentation validation of the segmented data to obtain a pre-segmentation result; and

a segmentation merging component configured to receive a server segmentation result, returned from an asynchronous server call, and merge it with the pre-segmentation result to obtain a merged segmentation result, the input control generation system updating the input control display based on the merged segmentation result.

Example 20 is the client system of any or all previous examples and further comprising:

an error display component configured to display an error indicator on the input control display, in a specific segment context, indicative of an error in the received, segmented data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an input control generation system that generates an input control display that has a data entry user input mechanism configured to receive segmented data;
a pre-segmentation component configured to perform a pre-segmentation validation of the segmented data to obtain a pre-segmentation result; and
a segmentation merging component configured to receive a server segmentation validation result and merge it with the pre-segmentation result to obtain a merged segmentation result, the input control generation system updating the input control display based on the merged segmentation result.

2. The computing system of claim 1 and further comprising:
a server interaction system configured to detect a server call trigger and, in response, make an asynchronous server call with the received, segmented data, to obtain the server segmentation validation result.

3. The computing system of claim 2 and further comprising:
an error display component configured to display an error indicator on the input control display indicative of an error in the received, segmented data.

4. The computing system of claim 2 wherein the error display component generates the error indicator in a segment context that indicates an erroneous segment.

5. The computing system of claim 4 wherein the input control generation system is configured to generate the input control display with a structured data user input mechanism configured to receive the segmented data in a displayed segment structure, and an unstructured data user input mechanism configured to receive the segmented data in an unstructured form.

6. The computing system of claim 5 and further comprising:
a synchronization component configured to receive the segmented data in at least one of the structured data user input mechanism and the unstructured data user input mechanism and synchronize data displayed in at least another of the structured data user input mechanism and the unstructured data user input mechanism.

7. The computing system of claim 6 wherein the structured data user input mechanism includes a plurality of separate user input mechanisms, one corresponding to each of a plurality of different segments.

8. The computing system of claim 7 wherein the error display component displays an error indicator proximate each separate user input mechanism that corresponds to an erroneous segment.

9. The computing system of claim 4 wherein the error display component is configured to receive user selection of a displayed error indicator and, in response, display error detail information corresponding to the indicated error in the received, segmented data.

10. The computing system of claim 9 wherein the error detail information identifies a segment that has an erroneous segment value.

11. The computing system of claim 9 wherein the error detail information identifies a segment that is in an erroneous segment combination or in an erroneous segment sequence.

12. The computing system of claim 2 wherein the segmentation merging component identifies differences between data received through the data entry user input mechanism when the asynchronous server call is made and data received through the data entry user input mechanism when the server segmentation validation result is received and obtain a pre-segmentation result based on the server segmentation validation result and the differences.

13. The computing system of claim 12 wherein the segmentation merging component is configured to add the differences, to the server segmentation validation result, and, after adding the differences, obtain a pre-segmentation result until all differences have been added to the server segmentation validation result, to obtain the merged segmentation result.

14. A method, comprising:
displaying, on a client system, an input control display that has a data entry user input mechanism;
receiving segmented data through the data entry user input mechanism;
perform a pre-segmentation validation of the received, segmented data, on the client system to obtain a pre-segmentation result;
making an asynchronous server segmentation call to a server segmentation system;
receiving a server segmentation result from the server segmentation system, at the client system;
merging the server segmentation result with the pre-segmentation result to obtain a merged segmentation result; and
updating the input control display based on the merged segmentation result.

15. The method of claim 14 wherein displaying an input control display comprises:
displaying a structured data user input mechanism configured to receive the segmented data in a displayed segment structure; and
displaying an unstructured data user input mechanism configured to receive the segmented data in an unstructured form.

16. The method of claim 15 and further comprising:
synchronizing data displayed in the structured data user input mechanism and the unstructured data user input mechanism, based on data entered in the structured data user input mechanism or the unstructured data user input mechanism.

17. The method of claim 14 wherein merging comprises:
detecting differences between data received through the data entry user input mechanism when the asynchronous server call is made and data received through the data entry user input mechanism when the server segmentation result is received; and
performing pre-segmentation validation, on the client system, to obtain a pre-segmentation result based on the server segmentation result and the differences.

18. The method of claim 17 and further comprising:
displaying an error indicator, identifying a segment context, on the input control display indicative of an error in the received, segmented data.

19. A client computing system, comprising:
an input control generation system that generates an input control display that has a data entry user input mechanism configured to receive segmented data;
a pre-segmentation component configured to perform a pre-segmentation validation of the segmented data to obtain a pre-segmentation result; and
a segmentation merging component configured to receive a server segmentation result, returned from an asynchronous server call, and merge it with the pre-segmentation result to obtain a merged segmentation result, the input control generation system updating the input control display based on the merged segmentation result.

20. The client system of claim 19 and further comprising:
an error display component configured to display an error indicator on the input control display, in a specific segment context, indicative of an error in the received, segmented data.
